(19) United States
(12) Patent Application Publication
(10) Pub. No.: US 2009/0274863 A1
(43) Pub. Date: Nov. 5, 2009

(54) PROCESS AND SYSTEM FOR MAKING NOISE ABSORBER CARPET AND A NOISE ABSORBER CARPET MADE THEREFROM

(76) Inventor: Kohei Yamada, Hashima-gun (JP)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 12/113,550

(22) Filed: May 1, 2008

(51) Int. Cl. D03D 27/00; B29D 31/00

(52) U.S. Cl. 428/95; 264/243; 425/174.2

(57) ABSTRACT

A noise absorber carpet comprised of a fabric layer portion and a resinous backing layer portion, wherein the fabric layer portion and the resinous backing layer portion are heat bonded with a press into the noise absorber carpet. The press includes perforation pins and a cooling medium. The resinous backing layer portion is provided with noise absorbing perforations formed by contact with the perforation pins of the press and cooled by the cooling medium. The perforations are cooled by the cooling medium with the press simultaneously with the bonding of the resinous backing layer portion with the fabric layer portion and the cooling of the press by the cooling medium, thereby providing for instant curing and fixation of the shape of the perforations.

### TECHNICAL FIELD AND BACKGROUND OF THE INVENTION

The present invention generally relates to a process and a system to make a noise absorber carpet, rug or mat, hereinafter referred to as “carpet”, generally used where noise damping or absorption is desired, including cars, buses, trains and airplanes as well as buildings and houses. More particularly, this invention relates to a process and a system to make a noise absorber carpet comprised of a fabric layer portion and a perforated backing layer portion.

A conventional noise damping or absorber car carpet is generally comprised of a piled fabric layer and a resilient plastic backing layer. The backing layer is generally formed of a synthetic resin material such as a vinyl chloride resin material. Such a car carpet may effectively block noises coming from below but will not effectively absorb noises coming from above, rather repelling the noises back into the car compartment.

Many carpets also utilized a series of spikes on the underneath side for abrasion purposes. Typical carpets were constructed with the use of a heated press provided with spike pins to produce spikes. However, the spikes lacked sufficient rigidity because of the heat pressing operation. The spikes would not grasp underlying layers effectively due to this insufficient rigidity.

Therefore a need remains to provide a carpet with perforation spikes of sufficient rigidity and effective noise dampening characteristics.

### SUMMARY OF THE INVENTION

Therefore, it is an object of the present invention to provide a process to make a noise absorber carpet comprised of a fabric layer portion and a perforated resinous backing layer portion at low costs.

It is another object of the present invention to provide a system to make a noise absorber carpet comprised of a fabric layer portion and a perforated resinous backing layer portion with abrasion spikes at low costs.

Other objects of the present invention will be known from the following description.

These and other objects of the present invention are achieved in the preferred embodiments disclosed below by providing a noise absorber carpet comprised of a fabric layer and a resinous backing layer. The resinous backing layer is formed by heating a resinous material in a mold having perforation pins. The fabric layer portion and the resinous backing layer portion are bonded with a press, and the resinous backing layer is provided with noise absorbing perforations formed by contact with the perforation pins of the mold. The perforations are cooled by a cooling medium after the bonding of the resinous backing layer portion with the fabric layer portion, thereby providing for instant curing and fixation of the shape of the perforations.

According to another embodiment of the invention, the backing layer portion comprises a formed resin of an open-cell type.

According to another embodiment of the invention, the press is a flat press.

According to another embodiment of the invention, the noise absorbing perforations include noise absorbing pores.

According to another embodiment of the invention, the carpet further includes slippage prevention spikes formed by corresponding slippage prevention spikes in the mold.

According to another embodiment of the invention, a process for making a noise absorber carpet comprised of a fabric layer portion and a resinous backing layer portion is provided including the steps of providing an uncured resinous backing layer within a mold having perforation pins, heating the resinous backing layer to activate the resin, providing a fabric layer, pressing the fabric layer into the resinous backing layer while maintaining the heating process to the resinous backing layer, and providing a cooling medium to cool the mold to fix and cure the perforation pins within the backing layer thereby forming noise absorbing perforations in the resinous backing layer.

According to another embodiment of the invention, a system for making a noise absorber carpet including a fabric layer and a resinous backing layer is provided. The system includes a mold with perforation pins which is heated to activate the resinous backing layer and is pressed against a fabric layer to bond the resinous backing layer portion with the fabric layer. The perforation pins are cooled for instant curing and fixation of the shape of the perforations thereby providing for noise absorbing perforations in the resinous backing layer.

According to another embodiment of the invention, the system further includes an ultrasonic generator to provide ultrasonic vibrations.

According to another embodiment of the invention, the cooling medium is a fluid.

According to another embodiment of the invention, the cooling medium is water.

### BRIEF DESCRIPTION OF DRAWINGS

The subject matter that is regarded as the invention may be best understood by reference to the following description taken in conjunction with the accompanying drawing figures in which:

FIG. 1 shows a mold adapted for receiving a resinous material to form a resinous backing layer for a carpet;

FIG. 2a shows the mold of FIG. 1 having the resinous material applied within the mold;

FIG. 2b shows an enlarged partial view of the mold shown in FIG. 2a;

FIG. 3 shows the mold being heated in order to activate the resinous material;

FIG. 4 shows the fabric layer being placed upon the resinous material;

FIG. 5 shows the process of pressing the carpet for making a spiked noise absorber carpet comprised of a fabric layer and two perforated resinous backing layers;

FIG. 6 shows the mold being cooled by a cooling medium; and

FIGS. 7a, and 7b show a circular conical perforation pin and a star-shaped perforation pin, respectively;

### DETAILED DESCRIPTION OF PREFERRED EMBODIMENTS AND BEST MODE

Referring to the drawings wherein identical reference numerals denote the same elements throughout the various views, the process and the system of the present invention for making perforated noise absorber carpets are described hereunder in connection with the accompanying drawings.

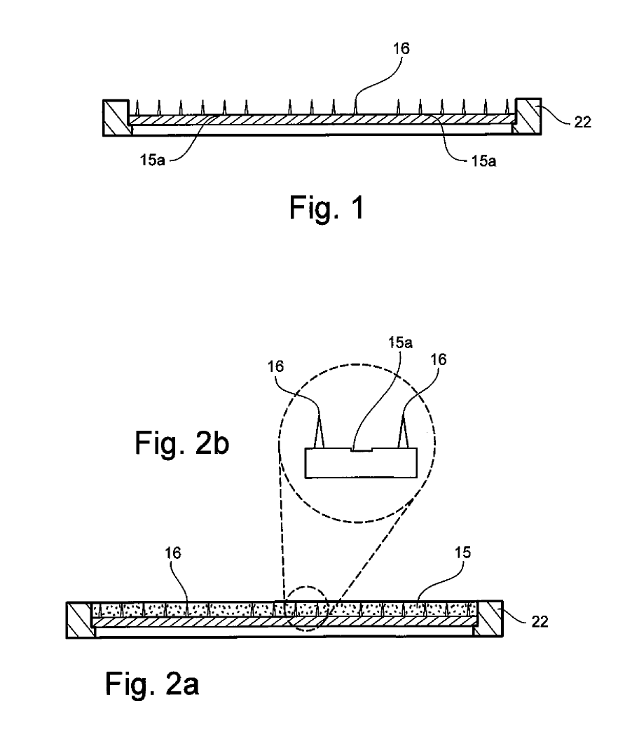

A spiked noise absorber carpet comprised of a fabric layer and a resinous backing layer according to a preferred embodiment of the present invention is shown in FIGS. 1 through 6.

FIG. 1 shows a carpet mold 22 having a plurality of perforation spikes 16. The perforation spikes 16 may extend from the mold 22 in any manner of appropriate directions or lengths and are not intended to be limited by the illustrations.

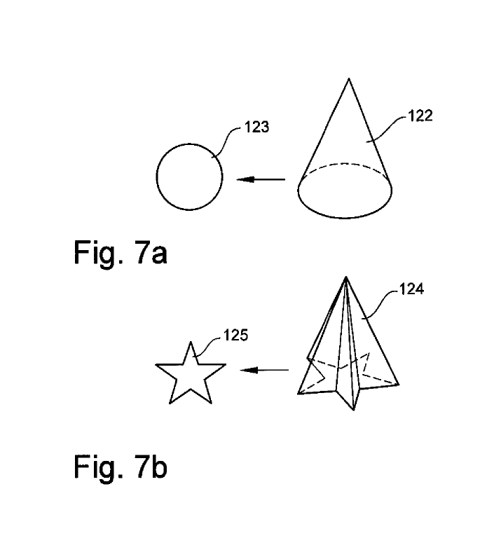

FIG. 2a shows the carpet mold 22 of FIG. 1 with a resinous backing layer 15 supplied within the mold. As shown in FIG. 2, the perforation pins 16 extend through the backing layer 15. In some embodiments, the perforation pins may extend only partially through the resinous backing layer. The pins may be any appropriate shape as shown in FIG. 7. As shown in FIG. 2b, the perforations pins 16 extend in a generally upward direction. Slippage prevention spikes 15a are provided within the mold.

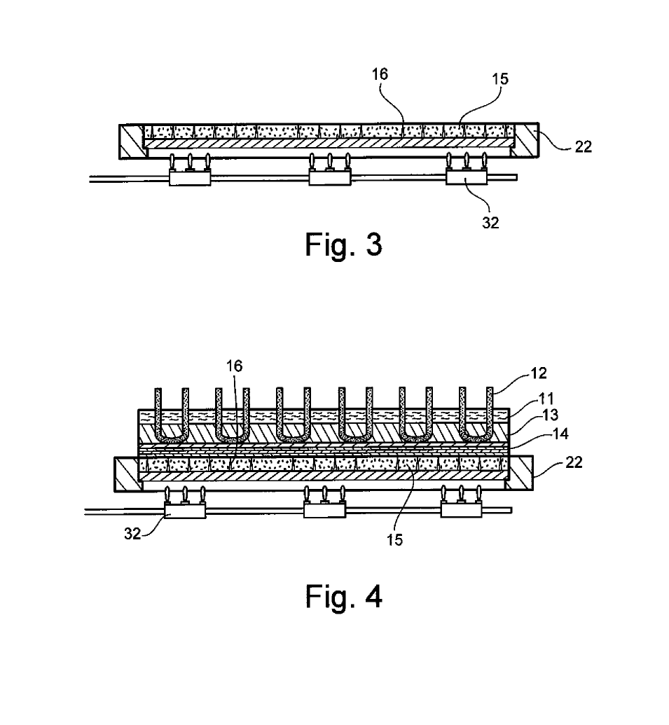

FIG. 3 shows the mold 22 being heated by a heating source 32. This activates the resinous backing layer 15 and prepares it for pressing onto the fabric layer 11 as shown in FIG. 4. The fabric used to provide the fabric sheet material forming the fabric layer 11 may be a nonwoven fabric, woven fabric, knitted fabric, paper or any combination thereof. The fabric layer may be provided with pile 12 to provide a cushioning effect and an improved appearance. The fabric layer may be a single layer or multiple layers, as shown with fabric layer 14 and internal fabric layer 13.

The resinous backing material 15 may be a styrene-butadiene-styrene copolymer, acrylonitrile-butadiene copolymer, urethane resin, styrene-butadiene rubber, acrylonitrile-butadiene rubber, butadiene rubber, natural rubber, isoprene rubber or a combination thereof.

The backing material 15 may contain a conventional foaming agent to provide continuous open cells in the backing material 15 such as fatty acid soap, sodiumalkylaryl sulfonate, higher alcohol sodium sulfate, or N-octadecyl monoamide disodium sulfosuccinate in order to improve the noise absorption property of the noise absorber carpet. Noises hitting and/or passing through the continuous open cells are effectively absorbed and damped.

The backing material 15 may also contain a conventional filler, extender, thickener and/or dispersant in order to improve the quality of the noise absorber carpet 10. The filler may be polyacrylic acid soda, carboxylmethylcellulose, aluminum hydroxide or antimony oxide. The thickener may be polyacrylic acid soda, carboxymethylcellulose, polyvinyl alcohol, casein or fermented polysaccharides. Low molecule polyacrylic acid soda is preferred. The dispersant may be tripolyphosphoric soda or hexametaphosphoric acid soda.

In an embodiment of the present invention, the heating source 32 heats the resinous material 15 in the range of 70 to 210° C. In another embodiment, the resinous material 15 is heated in the range of 70 to 150° C.

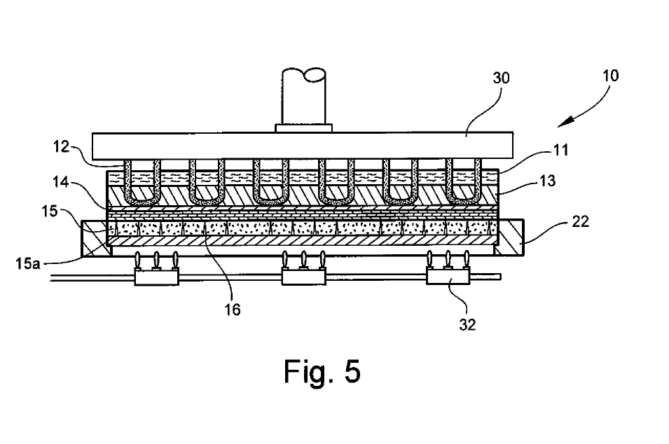

FIG. 5 shows the pressing of the noise absorber carpet 10 consisting of a fabric layer 11 on which pile 12 is provided, perforated adhesive layer 14, internal fabric layer 13 and spiked resinous backing layer 15 having slippage prevention spikes 15a. The piled fabric layer 11 and the internal fabric layer 13 are bonded with the perforated adhesive layer 14. The internal fabric layer 13 is heat bonded with the resinous backing layer 15.

The perforated adhesive layer 14 may be prepared by forming a web-like adhesive net and heat pressing the adhesive net between the two fabric layers 11 and 13. The perforated adhesive layer 14 partially let noises coming through the piled top fabric layer 14 pass through and be absorbed by the internal fabric layer 13 and the resinous backing layer 15, and partially consumes noise energy by vibrating between the two fabric layers 11 and 13.

The top fabric layer 11 and the internal fabric layer 13 may be of an identical fabric material or may be of different fabric materials. In an embodiment of the present invention, the top fabric layer 11 is a nonwoven polyester fabric sheet of 300 g/m² and the internal fabric layer 13 is a nonwoven polyester fabric sheet of 300 g/m². In another embodiment of the present invention, the top fabric layer 11 is a nonwoven polyester fabric sheet of 200 g/m² and the internal fabric layer 13 is a nonwoven polyester fabric sheet of 350 g/m². In another embodiment of the present invention, the fiber used in the top fabric layer 11 and the fiber used in the internal fabric layer 13 are different in fiber size.

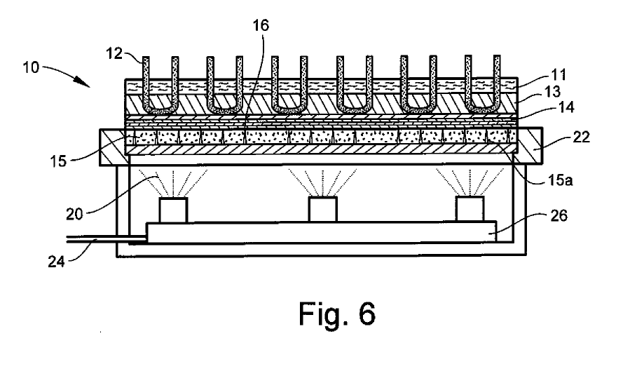

FIG. 6 shows the noise absorber carpet 10 being cooled by a cooling medium 26. The press 22 may be cooled by a cooling medium 26 in a range between 10 to 50° C. to assist formation of the perforations 16. The cooling medium 26 may employ a cooling gas 20 that is supplied from an external source 24. An ultrasonic generator is connected with the press to provide ultrasonic generations.

FIGS. 7a and 7b show various shapes of perforation pins 16 as may be used for the present invention and are not intended as limiting but are provided for illustration purposes only. In an embodiment of the present invention, the perforation pin 16 of FIG. 2 and FIG. 2a is a circular cone 122 to provide circular perforations 123. In another embodiment of the present invention, the perforation pin 16 of FIGS. 2 and 2a is a star-shaped cone 124 to provide star-shaped perforations 125. The size of the perforation pin 16 and thus the size of the perforation may be selected for a particular noise absorber carpet. In a preferred embodiment, the diameter of the perforation pin 16 is 1.5 mm. The foregoing has described a process for making a noise absorber carpet.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

I claim:

1. A noise absorber carpet comprised of a fabric layer portion and a resinous backing layer portion, wherein the resinous backing layer portion is formed by heating a resinous material in a mold having perforation pins, the fabric layer portion and the resinous backing layer portion are bonded with a press, and the resinous backing layer portion is provided with noise absorbing perforations formed by contact with the perforation pins of the mold and the perforations are cooled by a cooling medium after the bonding of the resinous backing layer portion with the fabric layer portion, whereby instant curing and fixation of the shape of the perforations is provided.

2. The noise absorber carpet according to claim 1, wherein the backing layer portion comprises a formed resin of an open-cell type.

3. The noise absorber carpet according to claim 1, wherein the press is a flat press.

4. The noise absorber carpet according to claim 1, wherein noise absorbing perforations include noise absorbing pores.

5. The noise absorber carpet according to claim 1, wherein the mold further has slippage prevention spike forming depressions, and the noise absorber carpet is provided with slippage prevention spikes formed by contact with the spike forming depressions of the mold.

6. A process for making a noise absorber carpet comprised of a fabric layer portion and a resinous backing layer portion, comprising the steps of:
(a) providing an uncured resinous backing layer within a mold having perforation pins;
(b) heating the resinous backing layer to activate the resin;
(c) providing a fabric layer portion;
(d) pressing the fabric layer portion into the resinous backing layer portion while maintaining the heating process to the resinous backing layer portion;
(e) providing a cooling medium to cool the mold to fix and cure the perforations within the backing layer thereby forming noise absorber perforations in the resinous backing layer.

7. The process according to claim 6, the mold further having slippage prevention spike forming depressions, the process further comprising providing the resinous backing layer portion with slippage prevention spikes formed by contact with the spike forming depressions in the mold.

8. The process according to claim 6, wherein the press is a flat press.

9. A system for making a noise absorber carpet comprised of a fabric layer portion and a resinous backing layer portion, the system comprising a mold having perforation pins which is heated to activate the resinous backing layer portion and is pressed against a fabric layer portion to bond the resinous backing layer portion with the fabric layer, wherein the perforation pins are cooled for instant curing and fixation of the shape of the perforations thereby providing for noise absorbing perforations in the resinous backing layer portion.

10. The system according to claim 9, wherein the mold further has depressions for forming slippage prevention spikes.

11. The system according to claim 9, wherein the mold further has an ultrasonic generator to provide ultrasonic vibrations.

12. The system according to claim 9, wherein the cooling medium is a fluid.

13. The system according to claim 9, wherein the press is a flat press.
